(19) United States
(12) Patent Application Publication
(10) Pub. No.: US 2017/0050326 A1
(43) Pub. Date: Feb. 23, 2017

(54) PERSONAL CARE TRIMMER HAVING ULTRATHIN FIXED BLADE AND MANUFACTURING METHOD FOR ULTRATHIN FIXED BLADE

(71) Applicant: SPECIALIFE (ZHUHAI) CO., LTD., Zhuhai (CN)

(72) Inventor: Tung Yan Lau, Zhuhai (CN)

(21) Appl. No.: 15/241,095

(22) Filed: Aug. 19, 2016

(30) Foreign Application Priority Data
Aug. 20, 2015 (CN) 201510514702.6

(51) Int. Cl. B26B 19/38; B26B 19/06

(52) U.S. Cl. CPC B26B 19/3846; B26B 19/06; B26B 19/3893

(57) ABSTRACT

The disclosure provides a personal care trimmer having an ultrathin fixed blade and a manufacturing method for an ultrathin fixed blade. The personal care trimmer comprises a body and a cutting head. The cutting head comprises a fixed blade and a movable blade, the fixed blade being fixed, the movable blade being driven by a drive device in the body to perform left-right reciprocating motion along the fixed blade to form a shearing surface. The fixed blade is an ultrathin fixed blade, and a blade body part, outside blade teeth, of the fixed blade is fixed with a blade supporting piece, such that the fixed blade is supported by the blade supporting piece so as not to deform. In the disclosure, an ultrathin fixed blade is adopted to be capable of trimming long hair in place once, the trimming position and length are more accurate, and the operation is easier.

### CROSS-REFERENCE TO RELATED APPLICATIONS

The present application claims the benefit of Chinese Patent Application No. 201510514702.6 filed on Aug. 20, 2015, the contents of which are hereby incorporated by reference.

### TECHNICAL FIELD

The disclosure relates to the technical field of personal care products, and in particular to a personal care trimmer.

### BACKGROUND

A using method for a traditional shaver refers to that: before the shaver is used, it is necessary to cut hair short, and then the hair with the residual length is cleanly shaven using the shaver. However, two operations are needed. In addition, because a fixed blade part of the traditional shaver is relatively thick, when the shaver is used, a contact surface between the shaver and skin is large, which may cause skin irritation or allergy. In order to solve the above two problems, it is necessary to make the fixed blade thin. However, the fixed blade, which is too thin, is easy to deform and unsafe to use.

If an ultrathin tool is produced in a machining manner, the tool will be bent, deformed or even broken. If a blade blank is formed by shearing in a die stamping manner, a sharp cutting edge cannot be achieved, which causes poor shearing capacity of the tool.

So, it is necessary to design a better personal care trimmer, which is intended to solve the above problems.

### SUMMARY

In view of the problems in the conventional art, the disclosure provides a personal care trimmer having an ultrathin fixed blade and a manufacturing method for an ultrathin fixed blade. The ultrathin fixed blade is adopted. The ultrathin fixed blade is formed using an etching technology, such that an ultrathin tool cannot deform, and the shearing capacity can be improved.

To this end, the disclosure adopts the technical solution as follows.

A personal care trimmer having an ultrathin fixed blade may comprise a body and a cutting head. The cutting head may comprise a fixed blade and a movable blade, the fixed blade being fixed, the movable blade being driven by a drive device in the body to perform reciprocating movement with respect to the fixed blade so as to achieve shearing.

The fixed blade may be an ultrathin fixed blade.

The personal care trimmer may further comprise a blade supporting piece, the blade supporting piece supporting the fixed blade or/and the movable blade without shielding blade teeth, needing to be exposed in shearing actions, of the fixed blade and the movable blade, the blade supporting piece being configured to prevent the fixed blade or/and the movable blade from deforming.

Preferably, the thickness of the fixed blade may be between 0.05 mm and 0.5 mm.

Optionally, the cross section of the blade supporting piece may be C-shaped, and both the movable blade and the fixed blade may be disposed in an opening of the blade supporting piece, wherein the fixed blade is fixedly attached to an inner surface of the blade supporting piece.

Preferably, an elastic piece configured to tightly press the movable blade against the fixed blade may be further disposed between the blade supporting piece and the movable blade. Or, an elastic piece may be disposed on a surface, adjacent to the movable blade, of the blade supporting piece, and may be configured to tightly press the movable blade against the fixed blade.

The cutting head may further comprise a blade rest, connected to the body and configured to fix the fixed blade, the movable blade and the blade supporting piece.

Optionally, the movable blade, the blade supporting piece and the fixed blade may be disposed in sequence from a bottom surface of the blade rest, and the blade supporting piece may be disposed between the movable blade and the fixed blade, wherein the fixed blade, the blade supporting piece and the blade rest are fixed in a screw manner, a laser welding manner or a plastic column hot-melting manner.

Preferably, an elastic piece configured to tightly press the movable blade against the fixed blade may be further disposed between the blade rest and the movable blade. Or, an elastic piece may be disposed on a surface, adjacent to the movable blade, of the blade rest, and may be configured to tightly press the movable blade against the fixed blade.

Optionally, the blade supporting piece, the fixed blade and the movable blade may be stacked in sequence, wherein the blade supporting piece and the fixed blade are fixed with the blade rest in a screw manner, a laser welding manner or a plastic column hot-melting manner, the movable blade is located between the fixed blade and the blade rest, the movable blade can move left and right with respect to the fixed blade, and an elastic piece is disposed between the movable blade and the blade rest and is configured to tightly press the movable blade against the fixed blade.

Optionally, the fixed blade, the movable blade and the blade supporting piece may be stacked in sequence, wherein the fixed blade is fixed with the blade rest in a screw manner, a laser welding manner or a plastic column hot-melting manner, the movable blade and the blade supporting piece are clamped between the fixed blade and the blade rest and can move left and right with respect to the fixed blade respectively, and an elastic piece is disposed between the blade supporting piece and the blade rest and is configured to tightly press the movable blade against the fixed blade.

In the above technical solution, the blade supporting piece may be of a platy structure.

Another optional technical solution is as follows. The blade supporting pieces may be disposed on side faces, away from each other, of the fixed blade and the movable blade respectively, and one of the blade supporting pieces, the fixed blade, the movable blade and the other blade supporting piece are stacked in sequence, wherein the edges of the sides, facing the blade teeth of the fixed blade and the movable blade, of the blade supporting pieces are set to be tooth-shaped, correspond to the blade teeth of the fixed blade and the movable blade, are supported to the blade teeth of the fixed blade or/and the movable blade, and do not go beyond the tips of the blade teeth.

The disclosure also provides a manufacturing method for an ultrathin fixed blade, which may comprise:

Step 1: cutting a coiled material to form a blade blank on the coiled material;

Step 2: cleaning and treating the surface of the blade blank;

Step 3: manufacturing an anti-corrosion protective layer on the surface of the blade blank, printing photosensitive materials in a blade region on the surface of the blade blank according to the blade design, and forming the anti-corrosion protective layer in a photosensitive material region reacts chemically under the action of light;

Step 4: etching the surface of the blade blank using a chemical solution, so as to obtain an ultrathin fixed blade, an etching region being a non anti-corrosion protective layer region; and

Step 5: removing the anti-corrosion protective layer on the surface of the ultrathin fixed blade.

Preferably, the photosensitive materials may be printed on the surfaces and edges of the blade blank, wherein the photosensitive materials at two opposite edges are printed to be saw-toothed, the saw-tooth shape corresponding to the blade tooth shape.

Preferably, when the photosensitive materials are printed at the saw-toothed edges, the saw-toothed edges of two opposite surfaces of the blade blank may be staggered, a projection of a printing region on one of the surfaces to the other surface may totally cover a printing region on the other surface, and after etching is completed, blade teeth at the edge of a tool may form a sharp cutting edge.

Optionally, the photosensitive materials may be not printed in a strip-shaped region on one of the surfaces of the blade blank. During etching, the strip-shaped region may be etched to form a groove, which does not run through the ultrathin fixed blade.

Optionally, the photosensitive materials may be photosensitive glue or photosensitive emulsions or photosensitive films.

Preferably, in Step 4, the chemical solution may be proportioned to contain 600 to 800 g/L of ferric chloride, 80 to 120 g/L of hydrochloric acid, 20 to 30 g/L of phosphoric acid and 80 to 100 g/L of sulfuric acid, the solution temperature may be 10 to 45° C., and the treatment time may be 15 to 20 min.

Preferably, in Step 5, the tool may be soaked into a sodium hydroxide solution so as to remove the anti-corrosion protective layer, the concentration of the sodium hydroxide solution being 40 to 60 g/L, the temperature of the sodium hydroxide solution being 50 to 80° C.

Optionally, after Step 5 is completed, the fixed blade may be electroplated with titanium metal.

Compared with the conventional art, the disclosure has the advantages as follows.

In the disclosure, an ultrathin fixed blade is adopted to be capable of trimming long hair in place once, the trimming position and length are more accurate, and the operation is easier. In addition, contact surfaces between blade teeth and hair are small, and accordingly, stimulation to skin is little during hair trimming, thereby improving the experience degree of a user.

An anti-corrosion protective layer is manufactured on the surface of a blade blank, and photosensitive materials are printed in a blade region; under the action of illumination, the photosensitive materials in the blade region react chemically so as to form the anti-corrosion protective layer; and then etching is performed to obtain an ultrathin fixed blade having blade teeth at the edge. In the disclosure, the ultrathin fixed blade is manufactured using a photochemical metal etching method without physical contacts, such that tool deformation is avoided, a sharp cutting edge of a tool can be ensured, and the shearing capacity of the tool is improved.

### BRIEF DESCRIPTION OF THE DRAWINGS

FIG. 1 is an overall structure diagram according to a first embodiment of the disclosure;

FIG. 2 is a breakdown structure diagram according to a first embodiment of the disclosure;

FIG. 3 is an amplification structure diagram of a cutting head in FIG. 2;

FIG. 4 is a diagram illustrating a combination manner of a fixed blade, a movable blade and a blade supporting piece according to a second embodiment of the disclosure;

FIG. 5 is a breakdown structure diagram of a cutting head according to a third embodiment of the disclosure;

FIG. 6 is a diagram illustrating a combination manner of a fixed blade, a movable blade and a blade supporting piece according to a fourth embodiment of the disclosure;

FIG. 7 is a diagram illustrating a combination manner of a fixed blade, a movable blade and a blade supporting piece according to a fifth embodiment of the disclosure;

FIG. 8 is a diagram illustrating combination of a blade supporting piece with a toothed support, a movable blade and a fixed blade according to a sixth embodiment of the disclosure;

FIG. 9 is a structural diagram of an ultrathin fixed blade according to an eighth embodiment of the disclosure;

FIG. 10 is a flowchart of a manufacturing method for an ultrathin fixed blade according to the disclosure;

FIG. 11 is a structural diagram of a blade blank of an ultrathin fixed blade according to an eighth embodiment of the disclosure; and

FIG. 12 is a sectional view of A-A in FIG. 11.

### DETAILED DESCRIPTION

The technical solutions in the embodiments of the disclosure will be clearly and completely described below in conjunction with the drawings in the embodiments of the disclosure. Obviously, the described embodiments are only some of the embodiments of the disclosure, not all of the embodiments. On the basis of the embodiments of the disclosure, all other embodiments obtained on the premise of no creative work of those skilled in the art shall fall within the protective scope of the disclosure.

### First Embodiment

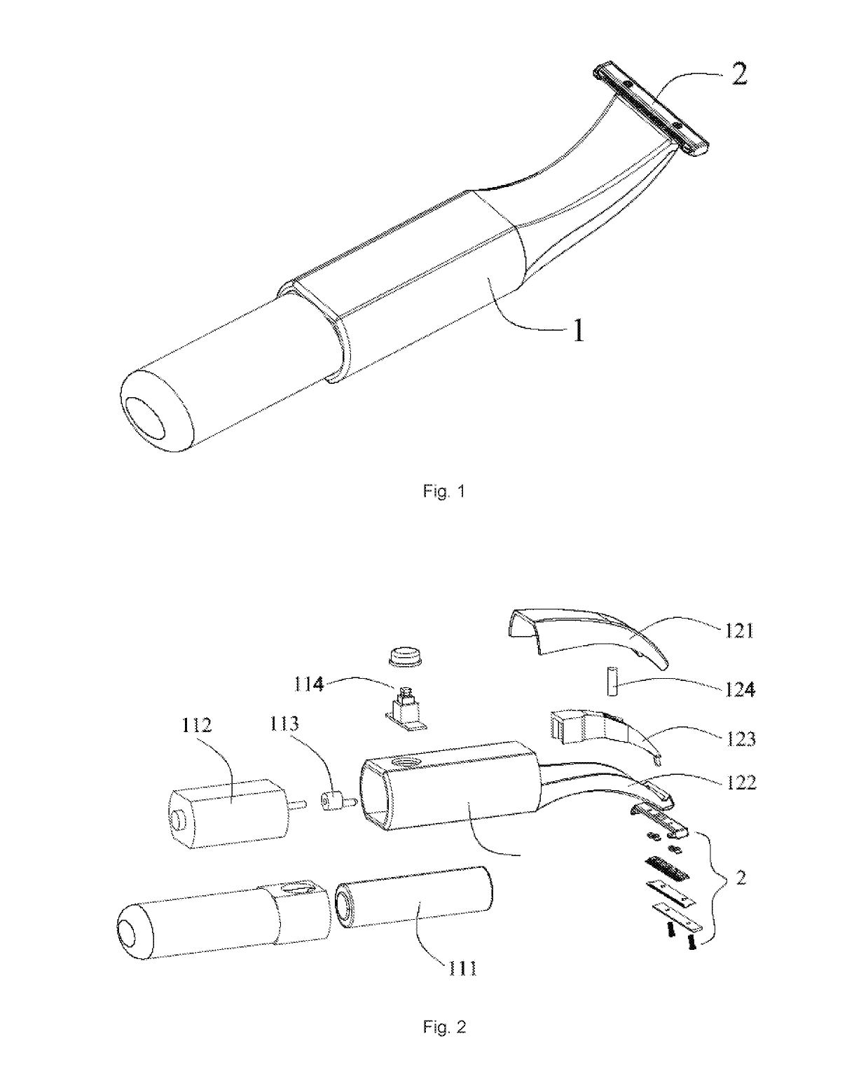

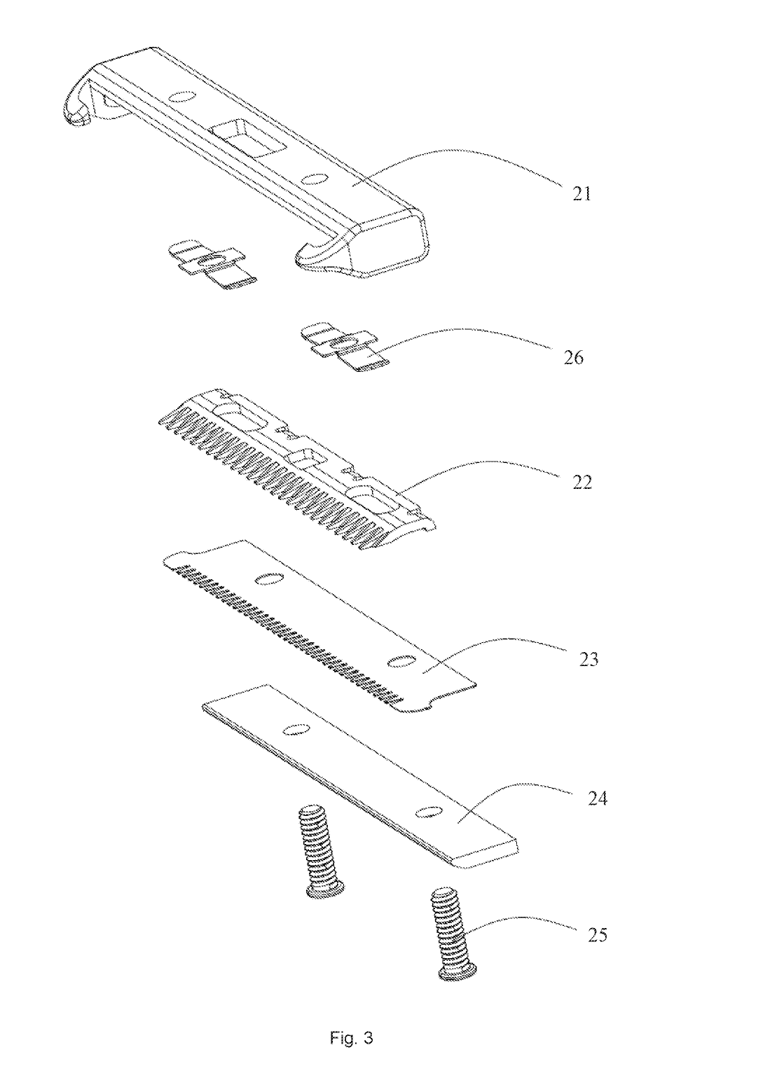

As shown in FIG. 1 to FIG. 3, the embodiment provides a personal care trimmer having an ultrathin fixed blade, which comprises a body 1 and a cutting head 2.

The body 1 comprises a main body 11 and a rocker arm portion 12; a battery 111, a motor 112 and an eccentric shaft 113 are disposed in the main body 11 in sequence; the rocker arm portion comprises an upper cover 121, a lower cover 122, and a rocker arm 123 disposed in the upper cover 121 and the lower cover 122 via a rocker arm shaft 124; the motor 112 is powered by the battery 111 under the control of a switch 114; and the motor 112 drives the eccentric shaft 113 to rotate, and the eccentric shaft 113 drives the rocker arm 123 to swing.

The cutting head 2 comprises: a blade rest 21, a movable blade 22, a fixed blade 23 and a blade supporting piece 24, the blade rest 21 being fixed to the end portion of the rocker arm portion 12.

The blade rest 21 comprises a bottom surface and two end side faces, and the movable blade 22, the fixed blade 23 and the blade supporting piece 24 are disposed in sequence from the bottom surface of the blade rest 21, wherein the blade supporting piece 24 is of a rectangular plate shape, and is attached to a blade body part, outside blade teeth, of the fixed blade 23 as a skin contact surface of the cutting head 2, the bottom surface and two side faces of the blade rest 21 are enclosed to form a frame, and the fixed blade 23 and the movable blade 22 are fixed in the frame.

Specifically, the fixed blade 23 and the blade supporting piece 24 are fixed with the blade rest 21 via screws 25. An elastic piece 26 is further disposed between the movable blade 22 and the blade rest 21 and is configured to tightly press the movable blade 22 to the fixed blade 23. The movable blade 22 can move left and right with respect to the fixed blade 23, a blade tooth edge of the movable blade 22 is correspondingly overlapped with that of the fixed blade 23, and when the movable blade 22 performs left-right reciprocating movement with respect to the fixed blade 23, the blade tooth edges of the two blades form a shearing surface.

The fixed blade 23 is an ultrathin fixed blade, and the thickness of the fixed blade is between 0.05 mm and 0.25 mm. The blade supporting piece 24 has a function of supporting the fixed blade 23 so as to avoid deformation caused by too-small thickness in usage.

Optionally, an elastic piece is disposed on a surface, adjacent to the movable blade 22, of the blade rest 21. That is, the elastic piece and the blade rest 21 are not split, but the elastic piece is disposed on an inner surface of the blade rest 21 instead and is configured to tightly press the movable blade 22 against the fixed blade 23.

### Second Embodiment

The embodiment provides a novel personal care trimmer having an ultrathin fixed blade, which is of another structure. The structure of the personal care trimmer of the embodiment is approximate to that of the first embodiment. The difference only lies in that a blade rest is not provided in the embodiment, and the structures of the two blade supporting pieces are different.

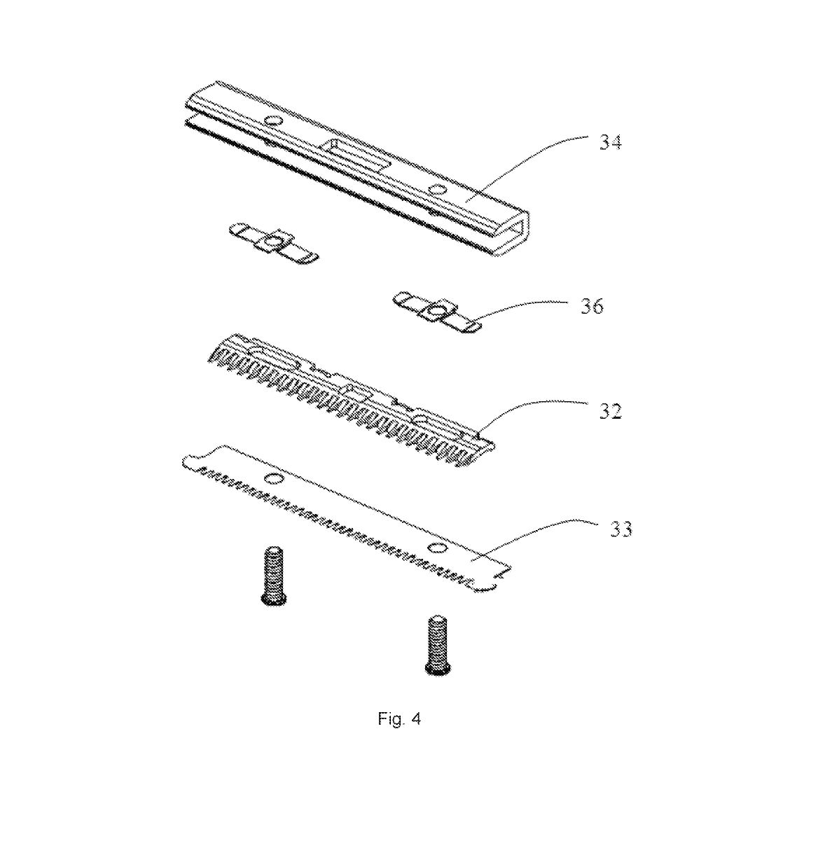

As shown in FIG. 4, the cross section of a blade supporting piece 34 is C-shaped, and both a movable blade 32 and a fixed blade 33 are disposed in an opening of the blade supporting piece 34, wherein the fixed blade 33 is fixedly attached to an inner surface of the blade supporting piece 34, and the movable blade 32 is located between the fixed blade 33 and the blade supporting piece 34.

In the embodiment, an elastic piece 36 configured to tightly press the movable blade 32 against the fixed blade 33 is further disposed between the blade supporting piece 34 and the movable blade 32. Or, an elastic piece 36 is disposed on a surface, adjacent to the movable blade, of the blade supporting piece 34, and is configured to tightly press the movable blade 32 against the fixed blade 33. The blade supporting piece 34 further comprises two end face fasteners which match two ends of the C-shaped blade supporting piece 34 respectively, such that the blade supporting piece 34 becomes a frame, similar to a structure formed by enclosing the blade rest 21 and the blade supporting piece 24 in the first embodiment.

### Third Embodiment

The embodiment provides a personal care trimmer having an ultrathin fixed blade, which is of another structure. The structure of the personal care trimmer of the embodiment is approximate to that of the first embodiment. The difference only lies in that the structures and installation positions of the two blade supporting pieces are different.

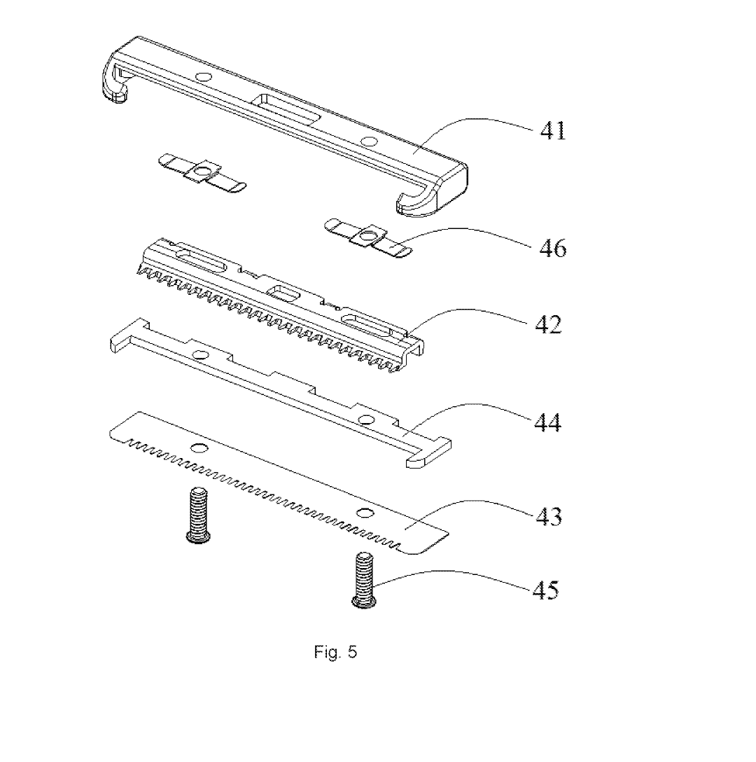

As shown in FIG. 5, a movable blade 42, a blade supporting piece 44 and a fixed blade 43 are disposed in sequence from a bottom surface of a blade rest 41, and the blade supporting piece 44 is disposed between the movable blade 42 and the fixed blade 43, wherein the fixed blade 43, the blade supporting piece 44 and the blade rest 41 are fixed via screws 45. The blade supporting piece 44 is of an approximate I shape consisting of an elongated middle and two wide ends, the elongated part is embedded in a concave surface of a blade body of the movable blade 42, and attachment of blade tooth edges of the fixed blade 43 and the movable blade 42 is not affected.

Preferably, an elastic piece 46 configured to tightly press the movable blade 42 against the fixed blade 43 is further disposed between the blade rest 41 and the movable blade 42. Or, an elastic piece is disposed on a surface, adjacent to the movable blade 42, of the blade rest 41, and is configured to tightly press the movable blade 42 against the fixed blade 43.

### Fourth Embodiment

The embodiment is structurally similar to the first embodiment. The difference only lies in that: combination manners of fixed blades, movable blades and blade supporting pieces are different.

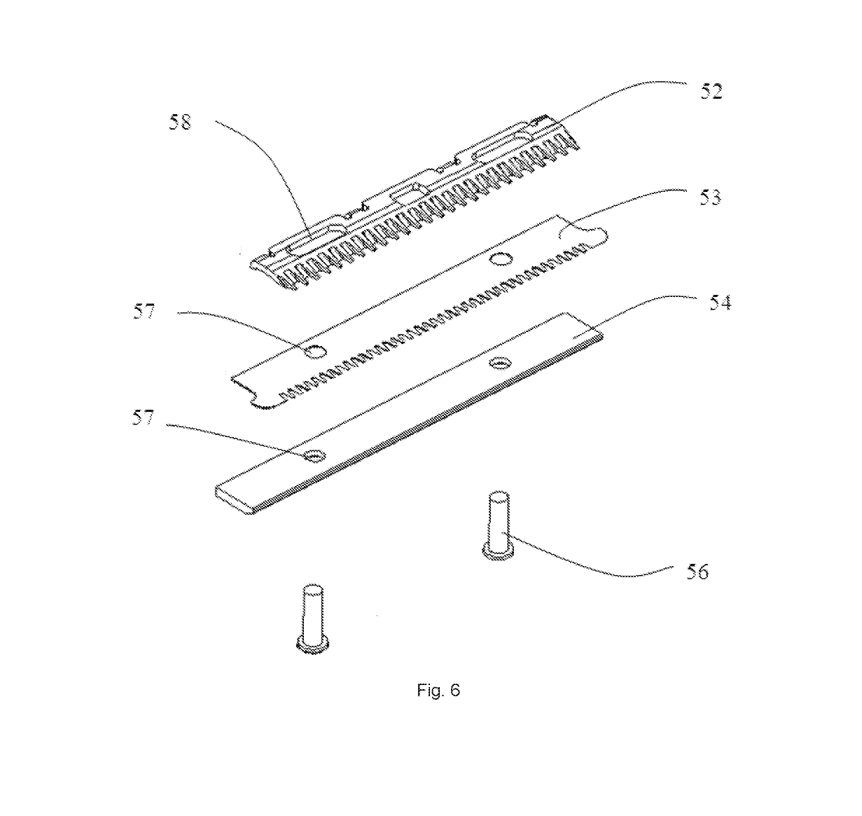

Specifically, as shown in FIG. 6, a blade supporting piece 54, a fixed blade 53 and a movable blade 52 are stacked in sequence, wherein the blade supporting piece 54 and the fixed blade 53 are fixed with a blade rest (identical to the blade rest in the first embodiment) in a laser welding manner, and the movable blade 52 is located between the fixed blade 53 and the blade rest. Moreover, the movable blade 52 can move left and right with respect to the fixed blade 53, and an elastic piece is disposed between the movable blade 52 and the blade rest and is configured to tightly press the movable blade 52 against the fixed blade 53.

More specifically, two pin holes 57 of which the radial sizes are equal to those of metal pins 56 are provided at the corresponding positions of the blade supporting piece 54 and the fixed blade 53, two through grooves 58 of which the radial sizes are farther larger than those of the metal pins 56 are provided at the corresponding position of the movable blade 52, the two metal pins 56 pass through the blade supporting piece 54, the fixed blade 53 and the movable blade 52 in sequence, the two metal pins 56 are fixedly welded with the pin holes 57 of the fixed blade 53 and the blade supporting piece 54 in a laser welding manner, and the movable blade 52 can move left and right with respect to the fixed blade 53.

### Fifth Embodiment

The embodiment is structurally similar to the first embodiment. The difference only lies in that: sequences of fixed blades, movable blades and blade supporting pieces are different.

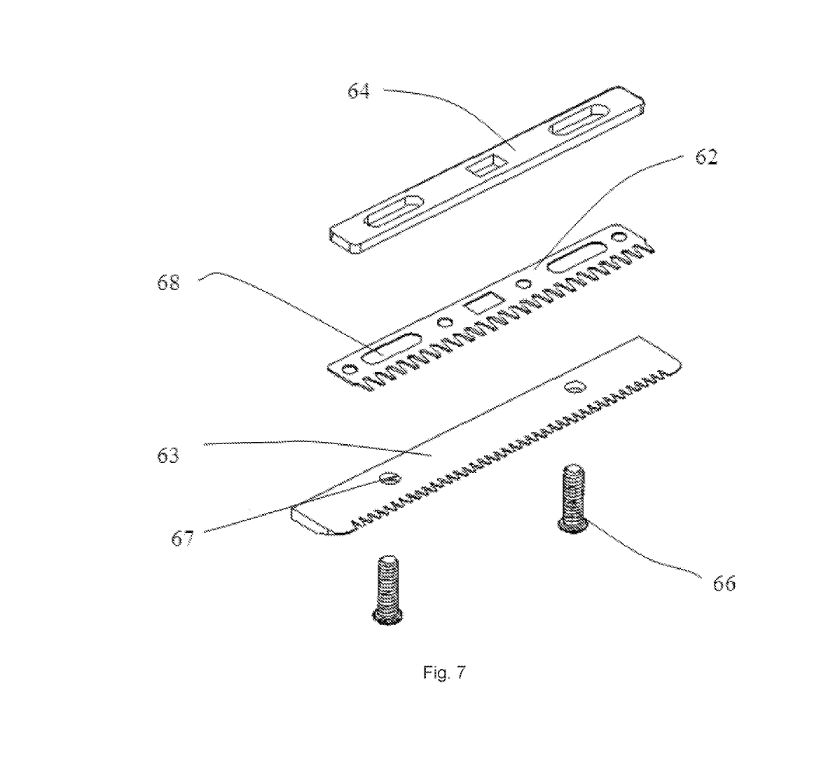

As shown in FIG. 7, a blade supporting piece 64, a movable blade 62 and a fixed blade 63 are disposed in sequence from a bottom surface of a blade rest (identical to the blade rest in the first embodiment), and an elastic sheet is disposed between the blade supporting piece 64 and the bottom surface of the blade rest, and is configured to tightly press the blade supporting piece 64 and the movable blade 62 against the fixed blade 63. Specifically, the fixed blade 63 is provided with two pin holes 67 of which the radial sizes are equal to those of screws 66, two through grooves 68 of which the radial sizes are farther larger than those of the screws 66 are provided at the corresponding positions of the movable blade 62 and the blade supporting piece 64, and the two screws 66 pass through the fixed blade 63, the movable blade 62 and the blade supporting piece 64 in sequence, and are locked and fixed with the blade rest. The blade supporting piece 64 and the movable blade 62 can move left and right with respect to the fixed blade 63.

### Sixth Embodiment

The embodiment provides a personal care trimmer having an ultrathin fixed blade, which is of another structure. The structure of the personal care trimmer of the embodiment is approximate to that of the first embodiment. The difference only lies in that the structures and installation positions of the two blade supporting pieces are different.

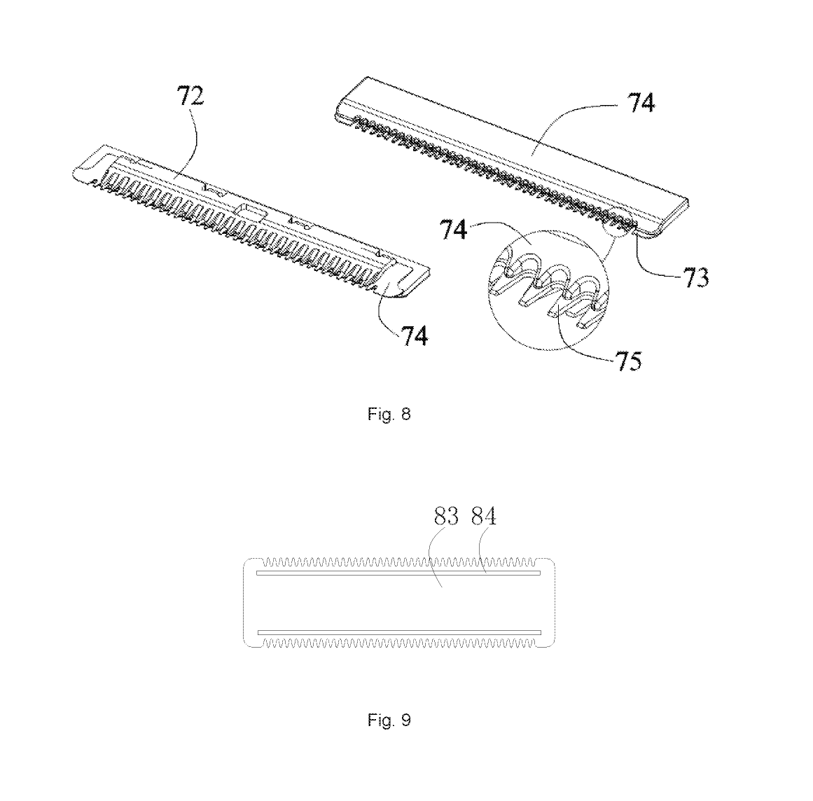

As shown in FIG. 8, blade supporting pieces 74 are disposed on side faces, away from each other, of a fixed blade 73 and a movable blade 72 respectively. That is, the blade supporting pieces 74 are disposed on the outer sides of the fixed blade 73 and the movable blade 72 respectively, and one of the blade supporting pieces 74, the fixed blade 73, the movable blade 72 and the other blade supporting piece 74 are stacked in sequence, wherein the edges of the sides, facing blade teeth 75 of the fixed blade 73 and the movable blade 72, of the blade supporting pieces 74 are set to be tooth-shaped, correspond to the blade teeth 75 of the fixed blade 73 and the movable blade 72, are supported to the blade teeth 75 of the fixed blade 73 or/and the movable blade 72, and do not go beyond the tips of the blade teeth 75. The end portions of the blade supporting pieces 74 are provided with toothed supports, the end faces can be extended to approach the tips of the blade teeth 75 of the fixed blade, hair cannot be stopped, the problem of low hair shearing efficiency is solved, and the availability of the ultrathin fixed blade is improved.

### Seventh Embodiment

The embodiment is structurally similar to the fifth embodiment. The difference only lies in that: combination manners of fixed blades, movable blades and blade supporting pieces are different. The fixed blade herein is fixed with a blade rest in a laser welding or plastic column hot-melting manner. That is, screw fixing is changed into laser welding or plastic column hot-melting fixing. The fixing principle is identical to that of the fourth embodiment.

In each of the above embodiments, the blade supporting piece cannot shield cutting edge parts of the fixed blade and the movable blade regardless of the shape.

The disclosure may be transformed in many ways without limits to the above embodiments. For instance, fixing between the fixed blade and the blade supporting piece and/or the blade rest may be, but is not limited to screw fixing or laser welding fixing or similar rivet fixing, fixing of all components in a hot-melting manner by replacing screws or metal pins with plastic columns.

The personal care trimmer in all of the above embodiments adopts an ultrathin fixed blade capable of trimming long hair in place once, the trimming position and length are more accurate, and the operation is easier. In addition, contact surfaces between blade teeth and hair are small, and accordingly, stimulation to skin is little during hair trimming, thereby improving the experience degree of a user. Meanwhile, a blade supporting piece is adopted to support the ultrathin fixed blade or a movable blade, such that the fixed blade or the movable blade can be prevented from deforming.

### Eighth Embodiment

As shown in FIG. 9, in the embodiment, the shape of an ultrathin fixed blade is different from that in the above embodiments, a groove 84 is provided on a surface, opposite to a movable blade, of a fixed blade 83, and blade teeth are disposed at two side edges of the fixed blade 83.

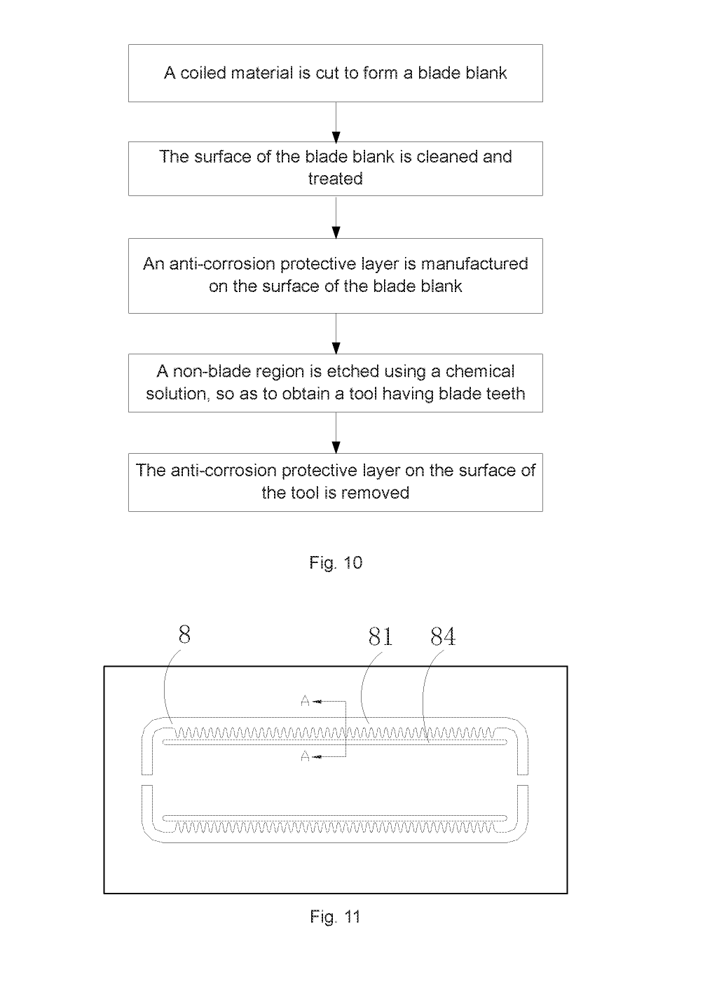

As shown in FIG. 10 and FIG. 11, the disclosure also provides a manufacturing method for an ultrathin fixed blade, which comprises the steps as follows.

Step 1: A coiled material is cut to form a blade blank 8 on the coiled material using a plate shearing machine, wherein the size of the blade blank 8 is slightly larger than that of a needed fixed blade, a plurality of blade blanks 8 is cut on the coiled material at one time generally, and adjacent blade blanks 8 are connected via a material belt.

Step 2: The surface of the blade blank 8 is cleaned and treated, and oil stain and an oxidation film on the surface of the metal blade blank 8 are removed.

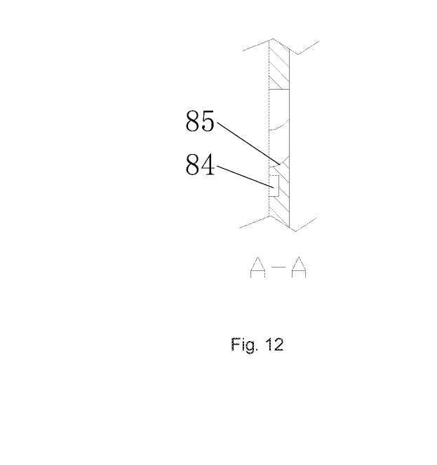

Step 3: An anti-corrosion protective layer is manufactured on the surface of the blade blank 8. Specifically, photosensitive materials are printed in a blade region 81 on the surface of the blade blank 8 according to the blade design, the photosensitive materials being photosensitive glue or photosensitive emulsions or photosensitive films. Illumination is accepted, and the photosensitive materials in the blade region react chemically under the action of light, such that an illumination part forms a glue film acid-proof layer namely the anti-corrosion protective layer. As shown in FIG. 12, in the embodiment, the fixed blade 83 is a blade having blade teeth at the edge, and the photosensitive materials are printed on two side surfaces and edges of a central region of the fixed blade 83 according to the blade design, wherein the photosensitive materials at two opposite edges are printed to be saw-toothed, the saw-tooth shape corresponding to the blade tooth shape.

Step 4: The surface of the blade blank 8 is etched using a chemical solution, an etching region being a non anti-corrosion protective layer region namely a non-blade region 81. After etching, metal in the non-blade region 81 is dissolved and eroded so as to obtain the ultrathin fixed blade 83 having the blade teeth at the edge finally, as shown in FIG. 12. In the disclosure, the fixed blade 83 is made from stainless steel. The chemical solution is proportioned to contain 600 to 800 g/L of ferric chloride, 80 to 120 g/L of hydrochloric acid, 20 to 30 g/L of phosphoric acid and 80 to 100 g/L of sulfuric acid, the solution temperature is 10 to 45° C., and the treatment time is 15 to 20 min. In other embodiments, the corresponding chemical solution can be proportioned according to a metal material of the fixed blade 83, the fixed blade 83 can be obtained by means of a chemical etching method without physical contacts, and the ultrathin fixed blade can be prevented from deforming in a manufacturing process.

Step 5: The anti-corrosion protective layer on the surface of the ultrathin fixed blade 83 is removed. Specifically, the fixed blade 83 is soaked into a sodium hydroxide solution so as to remove the anti-corrosion protective layer, the concentration of the sodium hydroxide solution being 40 to 60 g/L, the temperature of the sodium hydroxide solution being 50 to 80° C. The obtained fixed blade 83 can be directly used or after-treated. General after-treatment refers to electroplating the fixed blade 83 with titanium metal. After Step 6 is completed, the material belt is cut off along material connecting positions at two side edges of the fixed blade 83 to obtain a single fixed blade 83.

As shown in FIG. 11 and FIG. 12, in the embodiment, the photosensitive materials are not printed in two strip-shaped regions, close to the blade teeth, on one surface of the blade blank 8. During etching, the strip-shaped regions are etched to form a groove 84, which does not run through the fixed blade 83. By providing the groove 84 on the fixed blade 83, a friction surface between the fixed blade 83 and a movable blade 82 can be reduced, the resistance is reduced, the working temperature of the fixed blade 83 is reduced, and the hair shearing efficiency is improved.

Preferably, when the photosensitive materials are printed at the saw-toothed edges, the saw-toothed edges on the front and back surfaces of the blade blank 8 are staggered, and a projection of a printing region on the front surface to the back surface totally covers a printing region on the back surface, and after etching is completed, blade teeth at the edge of the fixed blade 83 form a sharp cutting edge 85. The shearing capacity of the fixed blade 83 is greatly improved.

In the disclosure, the ultrathin fixed blade is manufactured using a metal etching technology, and the fixed blade 83 having the blade teeth at the edge can be obtained, the blade teeth forming the sharp cutting edge 85. Physical contacts are not needed in the process of manufacturing the fixed blade 83, the fixed blade 83 cannot deform, and the process is applicable to manufacturing of various ultrathin fixed blades.

The ultrathin fixed blades in the first embodiment to the seventh embodiment can be manufactured using the manufacturing method in the eighth embodiment. Photosensitive materials are printed in a blade region on the surface of a blade blank; under the action of illumination, the photosensitive materials in the blade region react chemically so as to form an anti-corrosion protective layer; and then a region of a non anti-corrosion protective layer is etched to obtain an ultrathin fixed blade having blade teeth at the edge. In the disclosure, an ultrathin tool is manufactured using a photochemical metal etching method without physical contacts, such that tool deformation is avoided, a sharp cutting edge of the tool can be ensured, and the shearing capacity of the tool is improved.

The above embodiments are only used to illustrate the technical solutions of the disclosure without limitations. Although the disclosure is illustrated in detail with reference to the preferred embodiments, those skilled in the art shall understand that the technical solutions of the disclosure can be modified or equivalently replaced without departing from the purpose and scope of the technical solutions. The modifications or equivalent replacements shall fall within the scope of the claims of the disclosure.

What is claimed is:

1. A personal care trimmer having an ultrathin fixed blade, comprising a body and a cutting head, the cutting head comprising a fixed blade and a movable blade, the fixed blade being fixed, the movable blade being driven by a drive device in the body to perform reciprocating movement with respect to the fixed blade so as to achieve shearing, wherein
the fixed blade is an ultrathin fixed blade; and
the personal care trimmer further comprises a blade supporting piece, the blade supporting piece supporting the fixed blade or/and the movable blade without shielding blade teeth, needing to be exposed in shearing actions, of the fixed blade and the movable blade, the blade supporting piece being configured to prevent the fixed blade or/and the movable blade from deforming.

2. The personal care trimmer having an ultrathin fixed blade according to claim 1, wherein the thickness of the fixed blade is between 0.05 mm and 0.5 mm.

3. The personal care trimmer having an ultrathin fixed blade according to claim 1, wherein the cross section of the blade supporting piece is C-shaped, and both the movable blade and the fixed blade are disposed in an opening of the blade supporting piece, the fixed blade being fixedly attached to an inner surface of the blade supporting piece.

4. The personal care trimmer having an ultrathin fixed blade according to claim 3, wherein an elastic piece configured to tightly press the movable blade against the fixed blade is further disposed between the blade supporting piece and the movable blade; or, an elastic piece is disposed on a surface, adjacent to the movable blade, of the blade supporting piece, and is configured to tightly press the movable blade against the fixed blade.

5. The personal care trimmer having an ultrathin fixed blade according to claim 1, wherein the cutting head further comprises a blade rest, connected to the body and configured to fix the fixed blade, the movable blade and the blade supporting piece.

6. The personal care trimmer having an ultrathin fixed blade according to claim 5, wherein the movable blade, the blade supporting piece and the fixed blade are disposed in sequence from a bottom surface of the blade rest, and the blade supporting piece is disposed between the movable blade and the fixed blade, the fixed blade, the blade supporting piece and the blade rest being fixed in a screw manner, a laser welding manner or a plastic column hot-melting manner.

7. The personal care trimmer having an ultrathin fixed blade according to claim 6, wherein an elastic piece configured to tightly press the movable blade against the fixed blade is further disposed between the blade rest and the movable blade; or, an elastic piece is disposed on a surface, adjacent to the movable blade, of the blade rest, and is configured to tightly press the movable blade against the fixed blade.

8. The personal care trimmer having an ultrathin fixed blade according to claim 5, wherein the blade supporting piece, the fixed blade and the movable blade are stacked in sequence, the blade supporting piece and the fixed blade are fixed with the blade rest in a screw manner, a laser welding manner or a plastic column hot-melting manner, the movable blade is located between the fixed blade and the blade rest, the movable blade can move left and right with respect to the fixed blade, and an elastic piece is disposed between the movable blade and the blade rest and is configured to tightly press the movable blade against the fixed blade.

9. The personal care trimmer having an ultrathin fixed blade according to claim 5, wherein the fixed blade, the movable blade and the blade supporting piece are stacked in sequence, the fixed blade is fixed with the blade rest in a screw manner, a laser welding manner or a plastic column hot-melting manner, the movable blade and the blade supporting piece are clamped between the fixed blade and the blade rest and can move left and right with respect to the fixed blade respectively, and an elastic piece is disposed between the blade supporting piece and the blade rest and is configured to tightly press the movable blade against the fixed blade.

10. The personal care trimmer having an ultrathin fixed blade according to claim 8, wherein the blade supporting piece is of a platy structure.

11. The personal care trimmer having an ultrathin fixed blade according to claim 9, wherein the blade supporting piece is of a platy structure.

12. The personal care trimmer having an ultrathin fixed blade according to claim 1, wherein the blade supporting pieces are disposed on side faces, away from each other, of the fixed blade and the movable blade respectively, one of the blade supporting pieces, the fixed blade, the movable blade and the other blade supporting piece are stacked in sequence, and the edges of the sides, facing the blade teeth of the fixed blade and the movable blade, of the blade supporting pieces are set to be tooth-shaped, correspond to the blade teeth of the fixed blade and the movable blade, are supported to the blade teeth of the fixed blade or/and the movable blade, and do not go beyond the tips of the blade teeth.

13. A manufacturing method for an ultrathin fixed blade, comprising:
Step 1: cutting a coiled material to form a blade blank on the coiled material;
Step 2: cleaning and treating the surface of the blade blank;
Step 3: manufacturing an anti-corrosion protective layer on the surface of the blade blank, printing photosensitive materials in a blade region on the surface of the blade blank according to the blade design, and forming the anti-corrosion protective layer after a photosensitive material region reacts chemically under the action of light;
Step 4: etching the surface of the blade blank using a chemical solution, so as to obtain an ultrathin fixed blade, an etching region being a non anti-corrosion protective layer region; and
Step 5: removing the anti-corrosion protective layer on the surface of the ultrathin fixed blade.

14. The manufacturing method for an ultrathin fixed blade according to claim 13, wherein the photosensitive materials are printed on the surfaces and edges of the blade blank, the photosensitive materials at two opposite edges being printed to be saw-toothed, the saw-tooth shape corresponding to the blade tooth shape.

15. The manufacturing method for an ultrathin fixed blade according to claim 14, wherein when the photosensitive materials are printed at the saw-toothed edges, the saw-toothed edges of two opposite surfaces of the blade blank are staggered, a projection of a printing region on one of the surfaces to the other surface totally covers a printing region on the other surface, and after etching is completed, blade teeth at the edge of the fixed blade form a sharp cutting edge.

16. The manufacturing method for an ultrathin fixed blade according to claim 13, wherein the photosensitive materials are not printed in a strip-shaped region on one of the surfaces of the blade blank; and during etching, the strip-shaped region is etched to form a groove, which does not run through the ultrathin fixed blade.

17. The manufacturing method for an ultrathin fixed blade according to claim 13, wherein the photosensitive materials are photosensitive glue or photosensitive emulsions or photosensitive films.

18. The manufacturing method for an ultrathin fixed blade according to claim 13, wherein in Step 4, the chemical solution is proportioned to contain 600 to 800 g/L of ferric chloride, 80 to 120 g/L of hydrochloric acid, 20 to 30 g/L of phosphoric acid and 80 to 100 g/L of sulfuric acid, the solution temperature is 10 to 45° C., and the treatment time is 15 to 20 min.

19. The manufacturing method for an ultrathin fixed blade according to claim 13, wherein in Step 5, the tool is soaked into a sodium hydroxide solution so as to remove the anti-corrosion protective layer, the concentration of the sodium hydroxide solution being 40 to 60 g/L, the temperature of the sodium hydroxide solution being 50 to 80° C.

20. The manufacturing method for an ultrathin fixed blade according to claim 13, wherein after Step 5 is completed, the fixed blade is electroplated with titanium metal.
